(19) United States
(12) Patent Application Publication
(10) Pub. No.: US 2024/0394535 A1
(43) Pub. Date: Nov. 28, 2024

(54) ARTIFICIAL NEURAL NETWORK PERFORMANCE PREDICTION METHOD AND DEVICE ACCORDING TO DATA FORMAT

(71) Applicant: SEOUL NATIONAL UNIVERSITY R&DB FOUNDATION, Seoul (KR)

(72) Inventors: Dongsuk JEON, Seoul (KR); Sun Woo LEE, Seoul (KR)

(21) Appl. No.: 18/795,391

(22) Filed: Aug. 6, 2024

Related U.S. Application Data
(63) Continuation of application No. PCT/KR2022/010832, filed on Jul. 22, 2022.

(30) Foreign Application Priority Data
Mar. 17, 2022 (KR) 10-2022-0033175

(51) Int. Cl. G06N 3/08

(52) U.S. Cl. CPC G06N 3/08

(57) ABSTRACT

Artificial neural network performance prediction method and device according to data format are proposed. The artificial neural network performance prediction method may comprise: determining a zone and an operand of an artificial neural network that uses a candidate data format; obtaining a first parameter gradient through a first simulation of the artificial neural network on input data by applying an original data format to the operand in the zone; obtaining a second parameter gradient through a second simulation of the artificial neural network on the input data by applying the candidate data format to the operand in the zone; and determining a performance indicator according to the candidate data format based on the first parameter gradient and the second parameter gradient. Therefore, it is possible to find a low-precision data format suitable for a neural network to be trained and to perform low-precision training with high performance.

### CROSS-REFERENCE TO RELATED APPLICATION

This application claims priority to and the benefit of PCT Patent Application No. PCT/KR2022/010832 filed on Jul. 22, 2022, and Korean Patent Application No. 10-2022-0033175 filed in the Korean Intellectual Property Office on Mar. 17, 2022, the entire contents of which are incorporated herein by reference.

### BACKGROUND

The present disclosure relates to artificial neural network performance prediction method and device, and particularly to artificial neural network performance prediction method and device according to data format which find a low-precision data format suitable for training the artificial neural network.

Description below is merely for the purpose of providing background information related to embodiments of the present disclosure and does not necessarily constitute the conventional technology.

Most artificial neural networks require a large amount of calculation for training and consumes high power. In order to solve this problem, research is continuously performed to apply low-precision data phenotype to train the artificial neural networks.

Recent research has shown that performance degradation was greatly reduced in some models by applying 8-bit floating-point data phenotypes, but which data phenotype is optimal for each model is not revealed yet.

In particular, recently developed large-scale artificial neural networks require a long time to be trained, and accordingly, it is impossible to check a relationship between training performance and data phenotype.

In addition, because there is no existing way to predict the training performance in advance, the performance has to be compared after training for an actual artificial neural network is completed, and in this case, the larger the neural network and the more the data, the more the costs for time and power required for the training rapidly increase.

Therefore, technology for predicting training performance of an artificial neural network according to data format is needed.

Meanwhile, the conventional art described above is technical information that the inventor has for deriving the present disclosure or obtained in the process of deriving the present disclosure and may not necessarily be said to be known art disclosed to the public before the present disclosure is filed.

### SUMMARY

In order to overcome the limitation described above, one object of the present disclosure is to provide artificial neural network performance prediction method and device which may determine an optimal data phenotype and a calculation circuit implementation method for the artificial neural network in a short time.

Objects of the present disclosure are not limited to the object described above, and other objects and advantages of the present disclosure that are not described above may be understood through the following description and will be more clearly understood through embodiments of the present disclosure. Also, it will also be appreciated that objects and advantages of the present disclosure may be implemented by means and combinations thereof as set forth in the claims.

According to an aspect of the present disclosure, an artificial neural network performance prediction method according to data format, which is performed by an artificial neural network performance prediction device including a processor, includes determining a zone and an operand of an artificial neural network that uses a candidate data format, obtaining a first parameter gradient through a first simulation of the artificial neural network on input data by applying an original data format to the operand in the zone, obtaining a second parameter gradient through a second simulation of the artificial neural network on the input data by applying the candidate data format to the operand in the zone, and determining a performance indicator according to the candidate data format based on the first parameter gradient and the second parameter gradient.

According to another aspect of the present disclosure, an artificial neural network performance prediction device according to data format includes a memory storing at least one instruction, and a processor, wherein, when the at least one instruction is executed by the processor, the at least one instruction causes the processor to determine a zone and an operand of an artificial neural network that uses a candidate data format, obtain a first parameter gradient through a first simulation of the artificial neural network on input data by applying an original data format to the operand in the zone, obtain a second parameter gradient through a second simulation of the artificial neural network on the input data by applying the candidate data format to the operand in the zone, and determine a performance indicator according to the candidate data format based on the first parameter gradient and the second parameter gradient.

Other aspects, features, and advantages in addition to the description above will become apparent from the following drawings, claims, and detailed description of the present disclosure.

According to embodiments, it is possible to compare performances of artificial neural networks according to data format in a short time and cost compared to the entire training.

According to embodiments, it is possible to find a data format suitable for a neural network to be trained in real time and perform low-precision training with high performance.

According to embodiments, it is possible to perform low-cost and high-performance neural network training by compensating for low performance which is the biggest drawback of low-precision training, and the artificial neural network performance prediction technology may also be applied to high-performance and high-efficiency NPU design optimized therefor.

Effects of the present disclosure are not limited to the description above, and other effects not described will be clearly understood by those skilled in the art from the description.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an artificial neural network performance prediction device according to an embodiment;

FIG. 2 is a flowchart of an artificial neural network performance prediction method according to an embodiment;

FIGS. 3A and 3B are diagrams illustrating zones in predicting performance of an artificial neural network performance according to an embodiment;

FIG. 4 is a diagram illustrating performance indicators for predicting performance of an artificial neural network according to an embodiment; and

FIGS. 5A, 5B and 5C are diagrams illustrating simulation of an artificial neural network performance prediction process according to an embodiment.

### DETAILED DESCRIPTION OF THE EMBODIMENTS

Hereinafter, the present disclosure will be described in more detail with reference to the drawings. The present disclosure may be implemented in many different forms and is not limited to the embodiments described herein. In the following embodiments, parts not directly related to the description are omitted to clearly describe the present disclosure, but this does not mean that such omitted elements are unnecessary when implementing a device or system to which the idea of the present disclosure is applied. In addition, the same reference numerals are used for identical or similar components throughout the specification.

In the following description, terms, such as first and second, may be used to describe various components, but the components should not be limited by the terms, and the terms are used only for the purpose of distinguishing one component from other components. In addition, in the following description, singular expressions include plural expressions, unless the context clearly indicates otherwise.

In the following description, it should be understood that terms, such as “comprise”, “include”, and “have”, are intended to designate the presence of features, numbers, steps, operations, configuration elements, components, or combinations thereof described in the specification and do not exclude in advance the presence or addition of one or more other features, numbers, steps, operations, configuration elements, components, or combinations thereof.

In order to implement an artificial neural network training process as a low-precision calculation, it is essential to check which parts of the calculation are sensitive to performance and which data phenotype shows better performance.

The general research requires a process of actually training multiple deep learning models and comparing the final performance. This means that simple tasks require less time and cost to be trained, but as a neural network becomes larger and the task becomes more complex, it takes a long time and much cost to compare various cases with each other through training.

An artificial neural network performance prediction technology according to the embodiment may compare how much each low-precision data phenotype affects performance without actually training each model.

The present disclosure will be described in detail below with reference to the drawings.

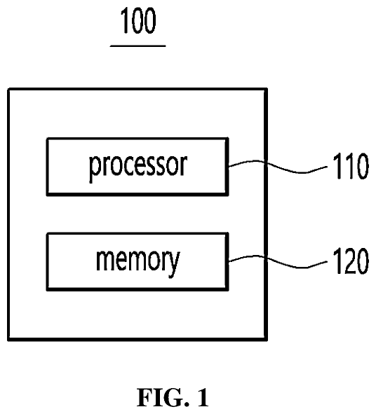

FIG. 1 is a block diagram of an artificial neural network performance prediction device according to an embodiment.

An artificial neural network performance prediction device 100 according to an embodiment includes a processor 110 and a memory 120 that stores at least one instruction. The configuration is an example, and the artificial neural network performance prediction device 100 may include some of the components illustrated in FIG. 1 or may additionally include components that are not illustrated in FIG. 1 but are required to operate the artificial neural network performance prediction device 100.

The processor 110 is a type of central processing unit and may control an operation of the artificial neural network performance prediction device 100 by executing the at least one instruction stored in the memory 120.

The processor 110 may include all types of devices capable of processing data. The processor 110 may refer to, for example, a data processing device built in hardware which includes a physically structured circuit to perform a function represented by codes or instructions included in a program.

The data processing device, which is built in hardware, may include a microprocessor, central processing unit (CPU), a processor core, a multiprocessor, an application-specific integrated circuit (ASIC), a field programmable gate array (FPGA), or so on but is not limited thereto. The processor 110 may include at least one processor.

The processor 110 may perform an artificial neural network performance prediction method according to an embodiment based on a program and instructions stored in the memory 120.

In addition to an artificial neural network, the memory 120 may store input data, intermediate data and calculation results generated during a parameter quantization process and artificial neural network calculation process.

Meanwhile, the artificial neural network includes various types of artificial neural networks, such as multi-layer perceptron (MLP), a convolutional neural network (CNN), a recurrent neural network (RNN), a long short term memory (LSTM), an auto encoder, a generative adversarial network (GAN), and a graph neural network (GNN), but is not limited thereto, and the artificial neural network performance prediction device 100 based on parameter quantization according to the embodiment is not limited to a specific artificial neural network and is applicable to predicting performances of various types of artificial neural networks.

The memory 120 may include an internal memory and/or an external memory, for example, a volatile memory such as dynamic random access memory (DRAM), static RAM (SRAM), or synchronous DRAM (SDRAM), a non-volatile memory such as one time programmable read only memory (OTPROM), programmable ROM (PROM), erasable PROM (EPROM), electrically EPROM EEPROM), mask ROM, flash ROM, NAND flash memory, or NOR flash memory, a flash drive such as a solid state drive (SSD), a compact flash (CF) card, a secure digital (SD) card, a micro-SD card, a mini-SD card, an extreme digital (xD) card, or a memory stick, or a storage device such as a hard disk drive (HDD). The memory 120 may include magnetic storage media or flash storage media but is not limited thereto.

The artificial neural network performance prediction device 100 may include the processor 110 and the memory 120 that stores at least one instruction, and when executed by the processor 110, the at least one instruction causes the processor 110 to determine a zone and an operand of an artificial neural network that uses a candidate data format, obtain a first parameter gradient through a first simulation of the artificial neural network on input data by applying an original data format to the operand in the determined zone, obtain a second parameter gradient through a second simulation of the artificial neural network on the input data by applying the candidate data format to the operand in the determined zone, and determine a performance indicator according to the candidate data format based on the first parameter gradient and the second parameter gradient.

In one example, the candidate data format includes at least one data format that is lower-precision than the original data format.

Here, the candidate data format is a low-precision data format, and the original data format is a high-precision data format or a full-precision data format that may be supported by the artificial neural network performance prediction device 100.

The low precision means, for example, INT4, INT8, FP130 (logarithmic format), FP134, FP143, FP152, or so on. Here, in FP1xy, x means the number of exponent bits of a floating point format, and y means the number of mantissa bits of the floating point format.

The high precision means, for example, a single precision floating point (FP32), a double precision floating point (FP64), a half precision floating point (FP16), a brain floating point (bfloat16), or so on.

In one example, when executed by the processor 110, the at least one instruction causes the processor 110 to determine a magnitude between the first parameter gradient and the second parameter gradient to determine a performance indicator and to determine a misalignment between the first parameter gradient and the second parameter gradient.

In one example, when executed by the processor 110, the at least one instruction causes the processor 110 to determine a first zone associated with a forward path of an artificial neural network in order to determine a zone and operand of the artificial neural network and to determine an activation value associated with forward propagation of the first zone as the operand.

In one example, when executed by the processor 110, the at least one instruction causes the processor 110 to determine a second zone associated with a backward path of an artificial neural network in order to determine a zone and operand of the artificial neural network and to determine at least one of an activation gradient and a weight gradient associated with reverse propagation of the second zone as the operand.

In one example, when executed by the processor 110, the at least one instruction causes the processor 110 to determine a third zone associated with at least one layer of an artificial neural network in order to determine a zone and operand of the artificial neural network, and to determine at least one of an activation value, an activation gradient, and a weight gradient of the third zone as the operand.

In one example, the candidate data format includes at least one candidate data format, and when executed by the processor 110, the at least one instruction causes the processor 110 to determine an optimal data format for the zone among at least one candidate data format based on a performance indicator.

When training an artificial neural network with low precision, an activation value excluding parameters, an error representing an activation gradient, and a weight gradient representing a parameter gradient may each be represented with low precision.

Accordingly, an error may occur in parameter update values and training may be made with inaccurate values, and the errors may lead to performance degradation in low-precision training.

The artificial neural network performance prediction method and device according to embodiments may compare performances of various data phenotypes with each other by comparing how accurately parameter update values may be obtained when each data format is applied in low-precision training.

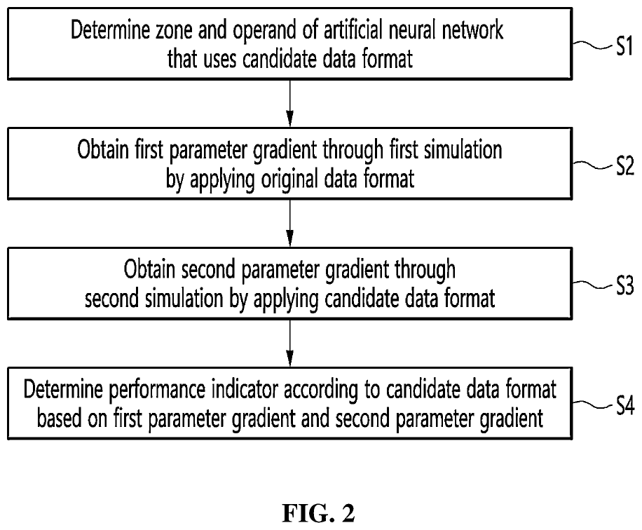

FIG. 2 is a flowchart of an artificial neural network performance prediction method according to an embodiment.

The artificial neural network performance prediction method according to the embodiment includes step S1 of determining a zone and an operand of an artificial neural network that uses a candidate data format, step S2 of obtaining a first parameter gradient through a first simulation of the artificial neural network on input data by applying an original data format to the operand in the determined zone, step S3 of obtaining a second parameter gradient through a second simulation of the artificial neural network on the input data by applying the candidate data format to the operand in the determined zone, and step S4 of determining a performance indicator according to the candidate data format based on the first parameter gradient and the second parameter gradient.

Step S1 determines, by the processor 110, the zone and operand of the artificial neural network to which the candidate data format is applied. That is, in step S1, the processor 110 determines a candidate zone and a candidate operand to which low-precision training is applied.

The candidate data format is a low-precision data format, and the original data format is a high-precision data format or a full-precision data format that may be supported by the artificial neural network performance prediction device 100. The candidate data format may include at least one data format with lower precision than the original data format.

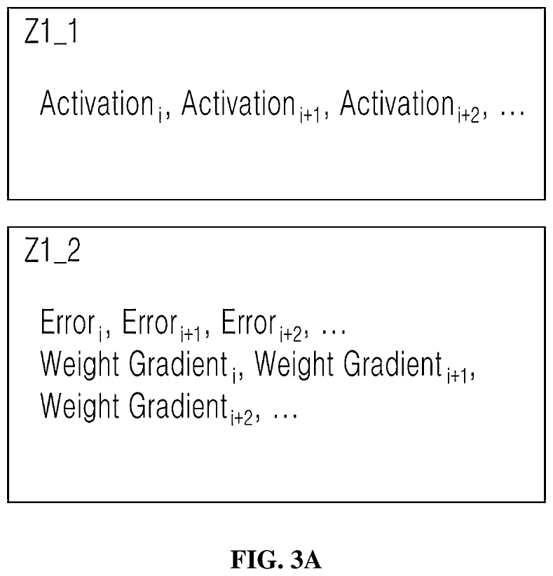

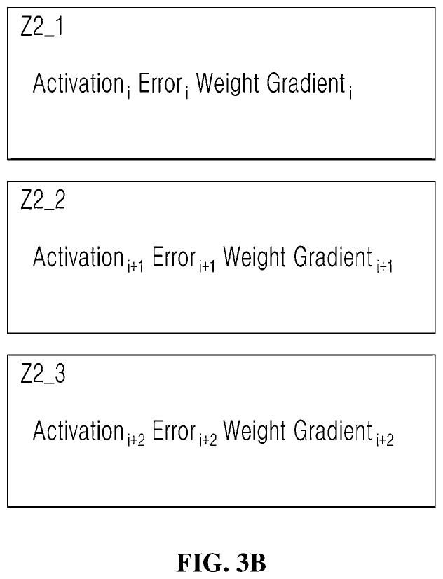

In step S1, the processor 110 may determine a zone on a forward path or backward path of the artificial neural network as the zone to which the candidate data format is applied. In step S1, the processor 110 may determine at least one layer of the artificial neural network as the zone to which the candidate data format is applied. This will be described below with reference to FIGS. 3A and 3B.

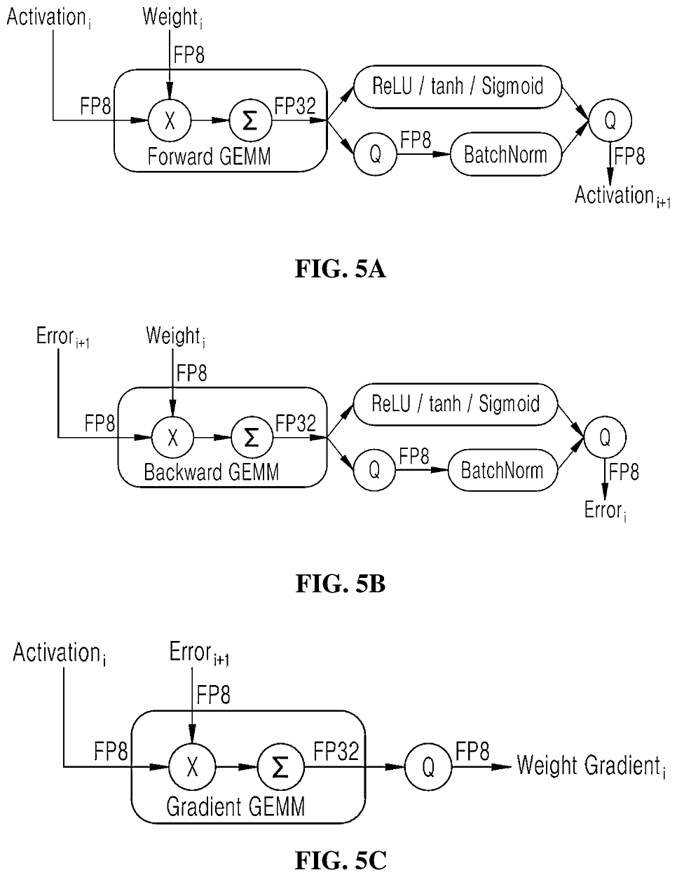

Except for the parameter, the operand includes at least one of an activation value, an error representing an activation gradient, and a weight gradient representing the parameter gradient. This will be described below with reference to FIGS. 5A, 5B, and 5C.

Step S2 obtaines, by the processor 110, the first parameter gradient through the first simulation of the artificial neural network on the input data by applying the original data format to the operand in the zone determined in step S1.

All or part of the training data to be trained in the neural network may be selected and used as the input data.

Simulation includes a process of determining the activation value along the forward path of the artificial neural network and determining a weight gradient along the backward path. For example, the simulation may be performed once on the input data. For example, simulation may not perform weight updating.

For example, the simulation includes a first simulation to which the original data format is applied and a second simulation to which the candidate data format is applied.

In step S2, the processor 110 determines the activation value along the forward path of the artificial neural network and determines the first weight gradient along the backward path.

Step S3 obtains, by the processor 110, the second parameter gradient through the second simulation of the artificial neural network on the input data by applying the candidate data format to the operand in the zone determined in step S1.

In step S3, the processor 110 determines the activation value along the forward path of the artificial neural network and determines the second weight gradient along the backward path in the same manner as the first simulation of step S2.

In step S4, the processor 110 determines a performance indicator according to the candidate data format based on the first parameter gradient and the second parameter gradient.

Step S4 may include a step of determining, by the processor 110, a magnitude between the first parameter gradient and the second parameter gradient and a step of determining, by the processor 110, a misalignment between the first parameter gradient and the second parameter gradient.

The performance indicator refers to an indicator for comparing errors occurring in values for updating parameters of an artificial neural network. The smaller the errors, the better the performance of the artificial neural network, and the performance indicator is related to the sizes of the errors.

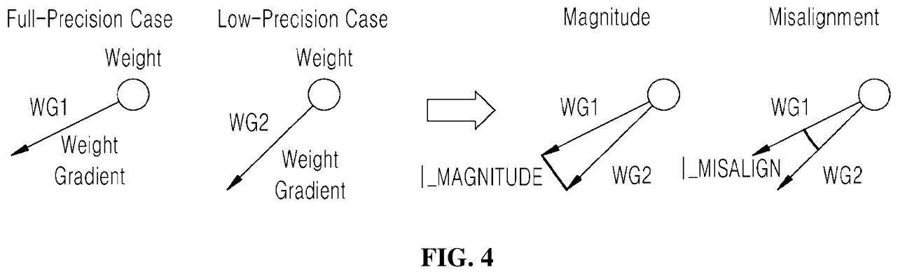

In one example, the performance indicator includes a magnitude indicator I_MAGNITUDE and a misalignment indicator I_MISALIGN, which will be described below with reference to FIG. 4.

The artificial neural network performance prediction method according to the embodiment may further include a step of determining, by the processor 110, an optimal data format for the zone determined in step S1 among at least one candidate data format based on the performance indicator determined in step S4. For example, the processor 110 may determine candidate data having the best performance indicator as an optimal data format.

In step S1 described above, the processor 110 may determine at least one zone to which the candidate data format is applied.

The processor 110 may perform step S1 to step S4 described above for all combinations, to which at least one candidate data format is applied, for each of the at least one zone determined in step S1, and may use a combination of the best performance indicators to the low-precision training of an artificial neural network.

In step S1, the processor 110 may determine at least one zone to which a candidate data format is to be applied, sequentially determine the candidate data format having the best performance indicator on each zone as the data format on each zone to use for the low-precision training of the artificial neural network.

FIGS. 3A and 3B are diagrams respectively illustrating zones in predicting performance of an artificial neural network according to an embodiment.

According to the embodiment, a neural network zone may be designated to use a candidate data format in step S1 of FIG. 2. For example, a different data format may be used for each layer of a neural network. For example, different data formats may be used for each operand (activation, an error, and a weight gradient).

FIG. 3A exemplarily illustrates a zone Z1_1 along a forward path and a zone Z1_2 along a backward path.

Referring to FIG. 2, step S1 may include a step of determining a first zone associated with a forward path of the artificial neural network and a step of determining an activation value associated with forward propagation of the first zone as an operand.

For example, the first zone Z1_1 may determine an activation value as an operand to which a candidate data format is applied.

Referring to FIG. 2, step S1 may include a step of determining a second zone associated with the backward path of the artificial neural network and a step of determining at least one of an activation gradient and a weight gradient associated with the backward propagation of the second zone as the operand.

For example, the second zone Z1_2 may determine at least one of an error and a weight gradient as an operand to which a candidate data format is applied.

FIG. 3B exemplarily illustrates zones Z2_1, Z2_2, and Z2_3 for each layer of the artificial neural network.

Referring to FIG. 2, step S1 may include a step of determining a third zone associated with at least one layer of an artificial neural network and a step of determining at least one of an activation value, an activation gradient, and a weight gradient of the third zone as an operand.

For example, the third zone Z2_1, Z2_2, and Z2_3 may determine at least one of the activation value, error, and weight gradient of each layer as an operand to which the candidate data format is applied.

FIG. 4 is a diagram illustrating performance indicators for predicting performance of an artificial neural network according to an embodiment.

The performance indicators of artificial neural network performance prediction according to the embodiment refers to indicators for comparing errors occurring in values for updating parameters of the artificial neural network with each other.

In one example, the performance indicators include a magnitude indicator I_MAGNITUDE and a misalignment indicator I_MISALIGN.

When an original weight gradient WG1 obtained with full precision without quantizing an operand and a weight gradient WG2 obtained by applying low-precision by quantizing the operand are given, a magnitude indicator refers to a magnitude error between two vectors.

When the original weight gradient WG1 obtained with full precision without quantizing the operand and the weight gradient WG2 obtained by applying low-precision by quantizing the operand are given, a misalignment indicator refers to a misalignment error between two vectors.

That is, the smaller the magnitude indicator I_MAGNITUDE or the misalignment indicator I_MISALIGNMENT, the more suitable the low-precision data format applied to the operand is to an artificial neural network.

FIGS. 5A, 5B and 5C are diagrams illustrating a simulation of an artificial neural network performance prediction process according to an embodiment.

In the simulation of step S3 in FIG. 2, the operand of the zone determined in step S1 is quantized and represented with low-precision by the same or different candidate data formats.

Here, the operand includes at least one of an activation value, an error representing an activation gradient, and a weight gradient representing a parameter gradient, except for parameters.

FIG. 5A exemplarily illustrates an operation on an activation value in a forward path of a simulation.

After an activation value Activation1 and a weight Weight1 of the current layer 1 are each quantized (Q) and forward-general-matrix-multiplied (forward GEMM) with low precision, each go through an activation function (ReLU/tanh/Sigmoid) or quantization (Q)-normalization (BatchNorm), and are output as a new activation parameter Activation1+1 that is quantized (Q) again to be forward-propagated to a subsequent layer (1+1).

FIG. 5B exemplarily illustrates an operation on an error in the backward path of a simulation.

An error Error1+1 backward-propagated from the subsequent layer 1+1 to the current layer 1 and the weight Weight1 of a current node are each quantized (Q) and backward-general-matrix-multiplied (backward GEMM), each go through the activation function (ReLU/tanh/Sigmoid) or quantization (Q)-normalization (BatchNorm), and output as a new error Error that is quantized (Q) again.

FIG. 5C exemplarily illustrates an operation on a weight gradient in a simulation.

The activation value Activation1 of the current node and the error Error1+1 back-propagated from the subsequent layer 1+1 to the current layer 1 are each quantized (Q) and gradient-general-matrix-multiplied (gradient GEMM), and then, are quantized (Q) again, and are output as a new weight gradient.

In addition, in order to check whether a performance prediction value of the proposed technique matches actual training performance, four integers and a floating point 8-bit data format were applied to ResNet-18, ResNet-101, MobileNet, 2-Layer LSTM, and a transformer model to be trained, and as a result, it is confirmed that all trends are consistent.

Artificial neural network performance prediction according to an embodiment is applicable to all types of neural network structures and tasks when performing low-precision training, and may find a data phenotype and calculation method that show the best performance in a short amount of time and cost when an artificial neural network is trained with low precision.

In particular, the artificial neural network performance prediction according to the embodiment is applicable when training a large-scale artificial neural network in an environment, such as cloud, mobile, and Internet of things (IoT). According to the embodiment, when trying to train a neural network with a low-precision data format, a suitable data format may be quickly found, and accordingly, when training various neural networks in the cloud, mobile, or IoT devices, the optimal data format may be selected in real time, low-power and low-precision training may be made without performance degradation, and high energy efficiency may be achieved in low-precision training.

Recently, the complexity of an artificial neural network model has increased significantly, and accordingly, even high-performance servers in a data center including multiple graphics processing units (GPUs) have difficulty in training the artificial neural network. Therefore, leading companies in processors for a server, such as IBM™ and Intel™, are also accelerating the development of dedicated processors that may train artificial neural networks with low precision.

The artificial neural network performance prediction technology according to the embodiment has a great advantage in that optimized data phenotypes and operational circuit structures for various types of large-scale artificial neural network structures and tasks may be derived in a short time and at low cost. Therefore, the artificial neural network performance prediction technology may be directly applied to the development of high-performance artificial neural network training processors or neural network processing units (NPUs) for edge devices.

The method according to the embodiment of the present disclosure described above may be implemented as computer-readable codes on a program-recorded medium. Non-transitory computer-readable recording media include all types of recording devices storing data that may be read by a computer system. The computer-readable non-transitory recording media include, for example, a hard disk drive (HDD), a solid state disk (SSD), a silicon disk drive (SDD), ROM, RAM, compact disk-ROM (CD-ROM), a magnetic tape, a floppy disk, an optical data storage device, and so on.

The description of the embodiments according to the present disclosure described above is for illustrative purposes, and those skilled in the art to which the present disclosure pertains may understand that the present disclosure may be easily transformed into another specific form without changing the technical idea or essential features of the present disclosure. Therefore, the embodiments described above should be understood in all respects as illustrative and not restrictive. For example, each component described as single may be implemented in a distributed manner, and similarly, components described as distributed may also be implemented in a combined form.

The scope of the present disclosure is indicated by the claims described below rather than the detailed description above, and all changes or modified forms derived from the meaning and scope of the claims and their equivalent concepts should be construed as being included in the scope of the present disclosure.

The present disclosure is derived from research conducted as part of the basic research project/new research support project in the field of science and engineering (Project number: 1711156062 and Project name: Development of a high-performance and low-precision learning processor capable of deep learning of an artificial neural network with high accuracy) supported by the Ministry of Science and ICT.

What is claimed is:

1. An artificial neural network performance prediction method according to data format which is performed by an artificial neural network performance prediction device including a processor, the artificial neural network performance prediction method comprising:
determining a zone and an operand of an artificial neural network that uses a candidate data format;
obtaining a first parameter gradient through a first simulation of the artificial neural network on input data by applying an original data format to the operand in the zone;
obtaining a second parameter gradient through a second simulation of the artificial neural network on the input data by applying the candidate data format to the operand in the zone; and
determining a performance indicator according to the candidate data format based on the first parameter gradient and the second parameter gradient.

2. The artificial neural network performance prediction method of claim 1, wherein
the candidate data format includes at least one data format that is lower in precision than the original data format.

3. The artificial neural network performance prediction method of claim 1, wherein
the operand includes at least one of an activation value, an error indicating an activation gradient, and a weight gradient.

4. The artificial neural network performance prediction method of claim 1, wherein the determining of the performance indicator includes:
determining a magnitude between the first parameter gradient and the second parameter gradient; and
determining a misalignment between the first parameter gradient and the second parameter gradient.

5. The artificial neural network performance prediction method of claim 1, wherein the determining of the zone and the operand of the artificial neural network includes:
determining a first zone associated with a forward path of the artificial neural network; and
determining an activation value associated with forward propagation of the first zone as the operand.

6. The artificial neural network performance prediction method of claim 1, wherein the determining of the zone and the operand of the artificial neural network includes:
determining a second zone associated with a backward path of the artificial neural network; and
determining at least one of an activation gradient and a weight gradient associated with backward propagation of the second zone as the operand.

7. The artificial neural network performance prediction method of claim 1, wherein the determining of the zone and the operand of the artificial neural network includes:
determining a third zone associated with at least one layer of the artificial neural network; and
determining at least one of an activation value, an activation gradient, and a weight gradient of the third zone as the operand.

8. The artificial neural network performance prediction method of claim 1, wherein
the candidate data format includes at least one candidate data format, and
the artificial neural network performance prediction method further comprises determining an optimal data format for the zone among the at least one candidate data format based on the performance indicator.

9. An artificial neural network performance prediction device according to data format comprising:
a memory storing at least one instruction; and
a processor,
wherein, when the at least one instruction is executed by the processor, the at least one instruction causes the processor to determine a zone and an operand of an artificial neural network that uses a candidate data format, obtain a first parameter gradient through a first simulation of the artificial neural network on input data by applying an original data format to the operand in the zone, obtain a second parameter gradient through a second simulation of the artificial neural network on the input data by applying the candidate data format to the operand in the zone, and determine a performance indicator according to the candidate data format based on the first parameter gradient and the second parameter gradient.

10. The artificial neural network performance prediction device of claim 9, wherein
the candidate data format includes at least one data format that is lower in precision than the original data format.

11. The artificial neural network performance prediction device of claim 9, wherein
when the at least one instruction is executed by the processor, in order to determine the performance indicator, the at least one instruction causes the processor to determine a magnitude between the first parameter gradient and the second parameter gradient and determine a misalignment between the first parameter gradient and the second parameter gradient.

12. The artificial neural network performance prediction device of claim 9, wherein
when the at least one instruction is executed by the processor, in order to determine the zone and the operand of the artificial neural network, the at least one instruction causes the processor to determine a first zone associated with a forward path of the artificial neural network and determine an activation value associated with forward propagation of the first zone as the operand.

13. The artificial neural network performance prediction device of claim 9, wherein
when the at least one instruction is executed by the processor, in order to determine the zone and the operand of the artificial neural network, the at least one instruction causes the processor to determine a second zone associated with a backward path of the artificial neural network and determine at least one of an activation gradient and a weight gradient associated with backward propagation of the second zone as the operand.

14. The artificial neural network performance prediction device of claim 9, wherein
when the at least one instruction is executed by the processor, in order to determine the zone and the operand of the artificial neural network, the at least one instruction causes the processor to determine a third zone associated with at least one layer of the artificial neural network and determine at least one of an activation value, an activation gradient, and a weight gradient of the third zone as the operand.

15. The artificial neural network performance prediction device of claim 9, wherein
the candidate data format includes at least one candidate data format, and
when the at least one instruction is executed by the processor, the at least one instruction causes the processor to determine an optimal data format for the zone among the at least one candidate data format based on the performance indicator.

16. A computer-readable non-transitory recording medium storing a computer program including at least one instruction for causing a processor to perform the artificial neural network performance prediction method according to claim 1.
